(19) United States
(12) Patent Application Publication
(10) Pub. No.: US 2018/0336635 A1
(43) Pub. Date: Nov. 22, 2018

(54) SYSTEMS AND METHODS FOR COMPARING ETF PORTFOLIOS BASED ON INTERNAL COMPOSITION

(71) Applicant: ETF Global, Inc., New York, NY (US)

(72) Inventors: Michael Rice, New York, NY (US); Christopher Romano, New York, NY (US)

(21) Appl. No.: 15/599,075

(22) Filed: May 18, 2017

(51) Int. Cl. G06Q 40/06; G06Q 30/02

(52) U.S. Cl. CPC G06Q 40/06; G06Q 30/0205

(57) ABSTRACT

Embodiments of the present invention are related to systems and methods for comparing ETF portfolios based on internal composition. Specifically, embodiments of the present invention are directed at automated system and methods for analyzing and generating measurements between two or more ETFs. Preferred embodiments of the invention leverage social network analysis (SNA) means and methods to compare constituents of portfolios in order to assist in measurements between such ETFs.

### FIELD OF THE INVENTION

Error! No sequence specified. Embodiments of the present invention are related to systems and methods for comparing ETF portfolios based on internal composition. Specifically, embodiments of the present invention are directed at automated system and methods for analyzing and generating measurements between two or more ETFs. Preferred embodiments of the invention leverage social network analysis (SNA) means and methods to compare constituents of portfolios in order to assist in measurements between such ETFs.

### BACKGROUND

Error! No sequence specified. There has long been a need in finance for ways to compare portfolios, either hypothetical or actual, in order to determine a best fit portfolio to meet the needs of investment clients. While it may be difficult to define a best fit portfolio, as it is highly dependent on the investment client or professional's needs, most investment strategies have been focused on the tradeoff between risk and return. Whole areas of research have been born out of this need.

Error! No sequence specified. There are over 16,000 different regulated investment companies (Mutual Funds, ETFs, UITs and CEFs) that contain over $17 Trillion in assets. Those numbers increase significantly when you include other investment products that are available to investors and portfolio managers. They included products like Hedge Funds, Separately Managed Accounts and Structured Products.

Error! No sequence specified. With such a wide variety of potential investments, there exists a need for users to compare the various products available to them. The majority of tools available today tend to use return-based analysis to accomplish this task either by looking at static profiles like correlation, distributions of returns or returns-based style analysis. The reason for the popularity of this type of analysis is because most firms do not have the underlying portfolio holdings of the products they are trying to compare. For firms that have the needed internal portfolio composition, analysis based on the makeup of the portfolio should provide much stronger results.

Error! No sequence specified. Therefore there is a need in the art for a system and method for comparing ETF portfolios based on internal composition and analysis of makeup of the portfolios. These and other features and advantages of the present invention will be explained and will become obvious to one skilled in the art through the summary of the invention that follows.

### SUMMARY OF THE INVENTION

Error! No sequence specified. Accordingly, it is an object of the present invention to for comparing ETF portfolios based on internal composition and analysis of makeup of the portfolios.

Error! No sequence specified. According to an embodiment of the present invention, a system for comparing ETF portfolios based on internal composition and analysis of makeup of the portfolios comprises: a computer processor; a non-volatile computer-readable memory; and a data communication interface, wherein the non-volatile computer-readable memory is communicatively connected to said processor and data communication interface and is configured with computer instructions configured to: receive an investment vehicle comparison request from a user; retrieve data associated with a plurality of investments, wherein each investment of said investments matches a type of investment identified in said investment vehicle comparison request; analyze constituents of each investment of said plurality of investments; calculate variance of investment vehicles, based at least in part on analysis of said constituents of each investment of said plurality of investments; calculate distance between said investment vehicles; and provide graphical display data related to calculated distance between said investment vehicles via said data communication interface.

Error! No sequence specified. According to an embodiment of the present invention, the system is further configured with computer instructions configured to cluster constituents of each investment of said plurality of investments based on one or more criteria associated with each constituent.

Error! No sequence specified. According to an embodiment of the present invention, a covariance matrix is calculated between said constituents, wherein said covariance matrix details the distance between each of said constituents.

Error! No sequence specified. According to an embodiment of the present invention, the criteria associated with each constituent is selected from the group comprising industry, geography and currency.

Error! No sequence specified. According to an embodiment of the present invention, the system is further configured with computer instructions configured to allocate each constituent to a specific industry.

Error! No sequence specified. According to an embodiment of the present invention, the system is further configured to cluster constituents of each investment of said plurality of investments based on the specific industry of said constituent.

Error! No sequence specified. According to an embodiment of the present invention, the system is further configured to define a feature set of each investment of said plurality of investments based on one or more criteria associated with each constituent.

Error! No sequence specified. According to an embodiment of the present invention, the system is further configured to generate a weighted average of each investment of said plurality of investments based said defined feature set.

Error! No sequence specified. According to an embodiment of the present invention, the system is further configured to generate a base portfolio.

Error! No sequence specified. According to an embodiment of the present invention, a method for comparing ETF portfolios based on internal composition and analysis of makeup of the portfolios, said method comprising the steps of: receiving an investment vehicle comparison request from a user; retrieving data associated with a plurality of investments, wherein each investment of said investments matches a type of investment identified in said investment vehicle comparison request; analyzing constituents of each investment of said plurality of investments; calculating variance of investment vehicles, based at least in part on analysis of said constituents of each investment of said plurality of investments; calculating distance between said investment vehicles; and providing graphical display data related to calculated distance between said investment vehicles via said data communication interface.

Error! No sequence specified. According to an embodiment of the present invention, the method further comprises the step of clustering constituents of each investment of said plurality of investments based on one or more criteria associated with each constituent.

Error! No sequence specified. According to an embodiment of the present invention, the method further comprises the step of calculating a covariance matrix between said constituents, wherein said covariance matrix details the distance between each of said constituents.

Error! No sequence specified. According to an embodiment of the present invention, the method further comprises the step of allocating each constituent to a specific industry.

Error! No sequence specified. According to an embodiment of the present invention, the method further comprises the step of clustering constituents of each investment of said plurality of investments based on the specific industry of said constituent.

Error! No sequence specified. According to an embodiment of the present invention, the method further comprises the step of defining a feature set of each investment of said plurality of investments based on one or more criteria associated with each constituent.

Error! No sequence specified. According to an embodiment of the present invention, the method further comprises the step of generating a weighted average of each investment of said plurality of investments based said defined feature set.

Error! No sequence specified. According to an embodiment of the present invention, the method further comprises the step of generating a base portfolio.

### BRIEF DESCRIPTION OF THE DRAWINGS

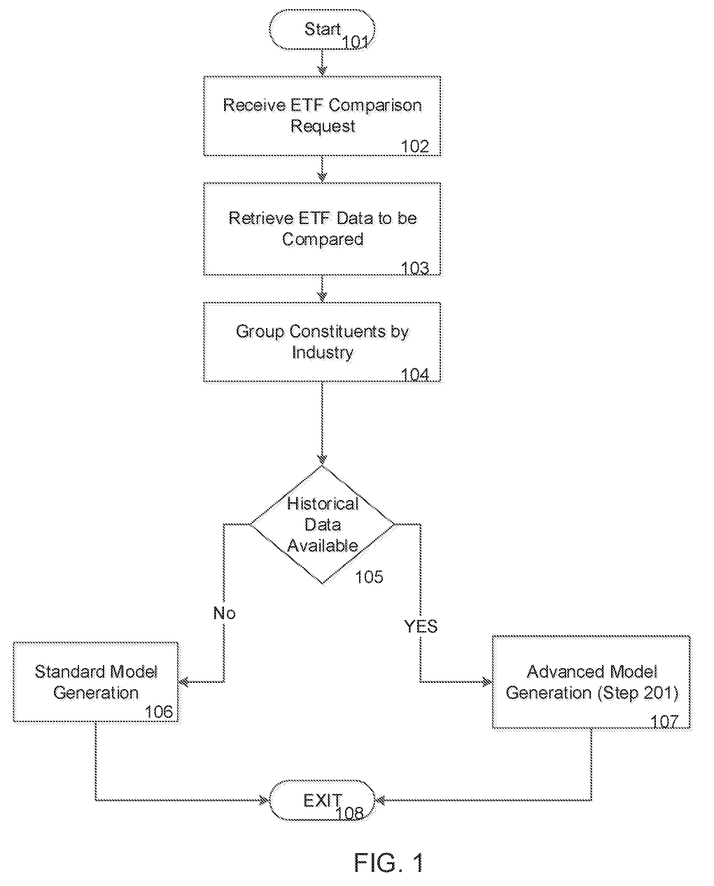

Error! No sequence specified. FIG. 1 illustrates an exemplary process flow for comparing ETF portfolios based on internal composition;

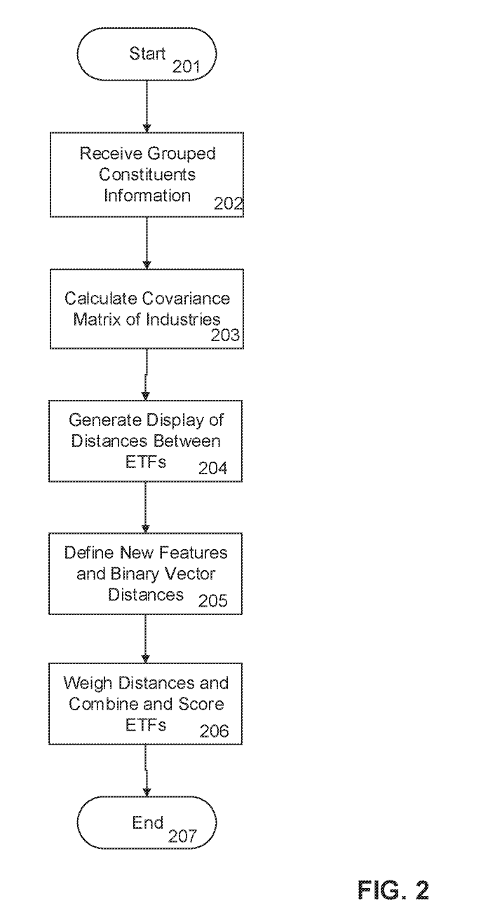

Error! No sequence specified. FIG. 2 illustrates an exemplary process flow for comparing ETF portfolios based on internal composition;

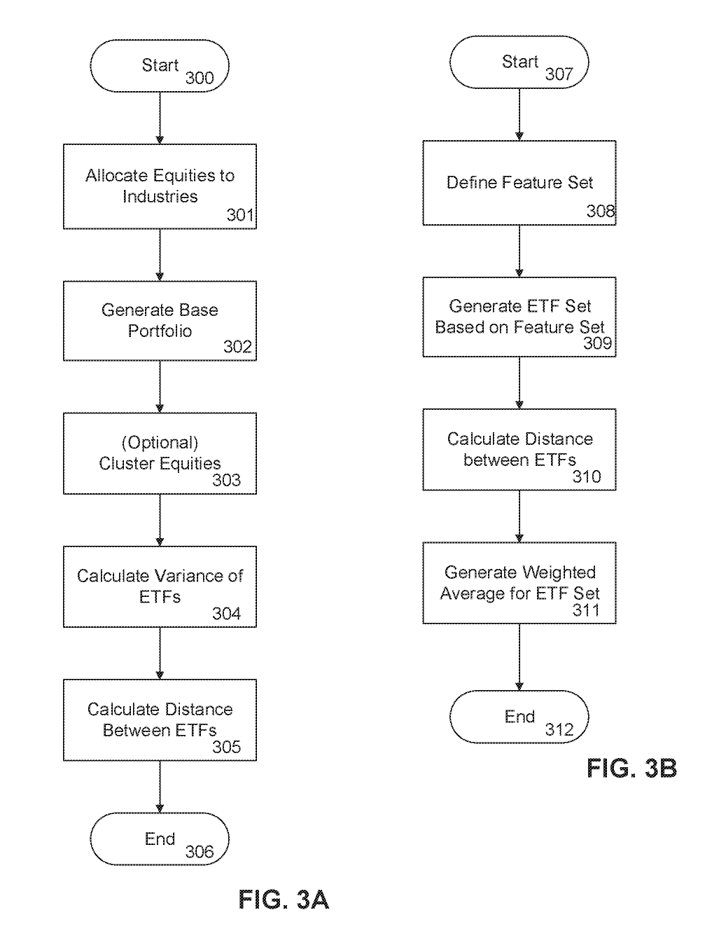

Error! No sequence specified. FIG. 3A illustrates an exemplary process flow for comparing ETF portfolios based on internal composition;

Error! No sequence specified. FIG. 3B illustrates an exemplary process flow for comparing ETF portfolios based on internal composition;

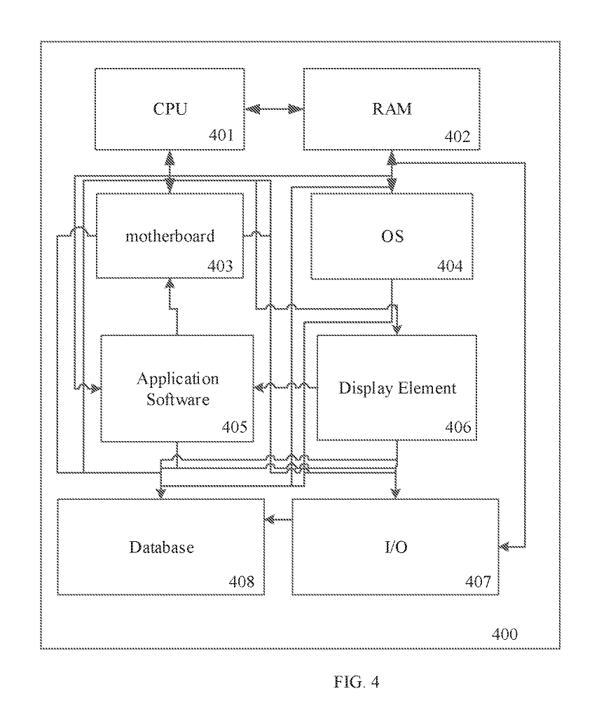

Error! No sequence specified. FIG. 4 illustrates a schematic overview of a computing device, in accordance with an embodiment of the present invention;

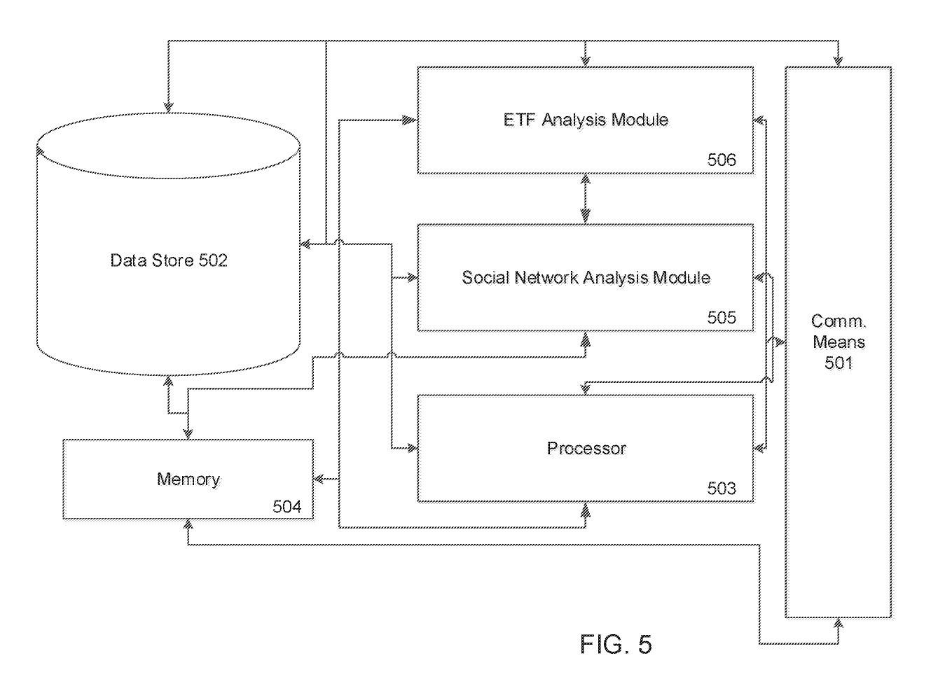

Error! No sequence specified. FIG. 5 illustrates a schematic overview of an embodiment of a system for comparing ETF portfolios based on internal composition;

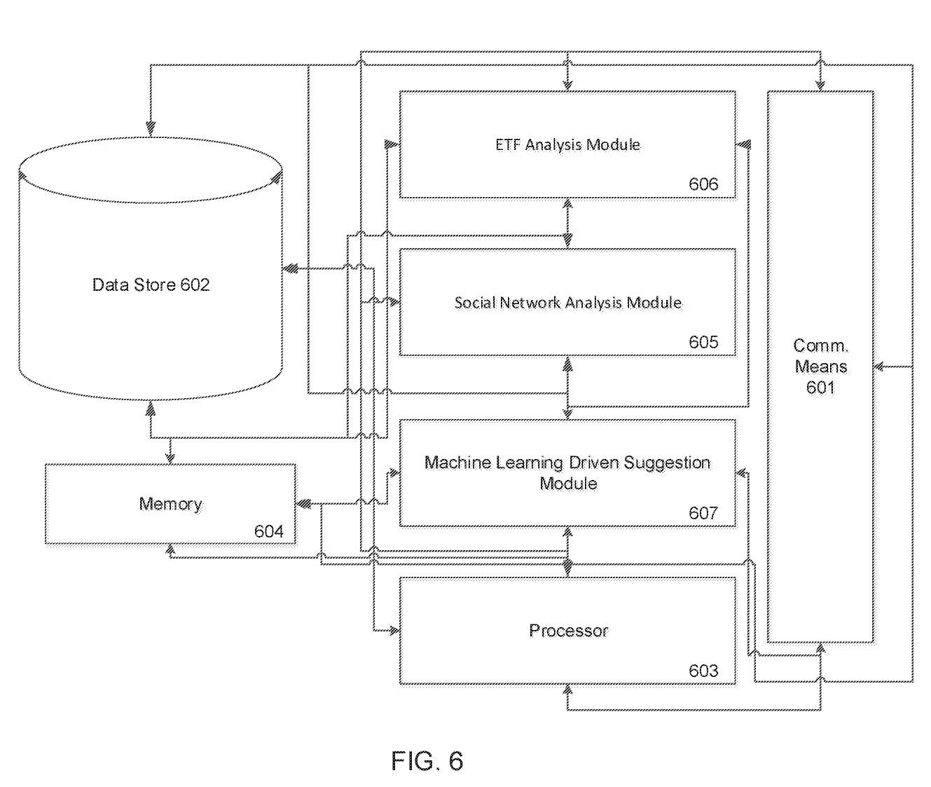

Error! No sequence specified. FIG. 6 illustrates a schematic overview of an embodiment of a system for comparing ETF portfolios based on internal composition;

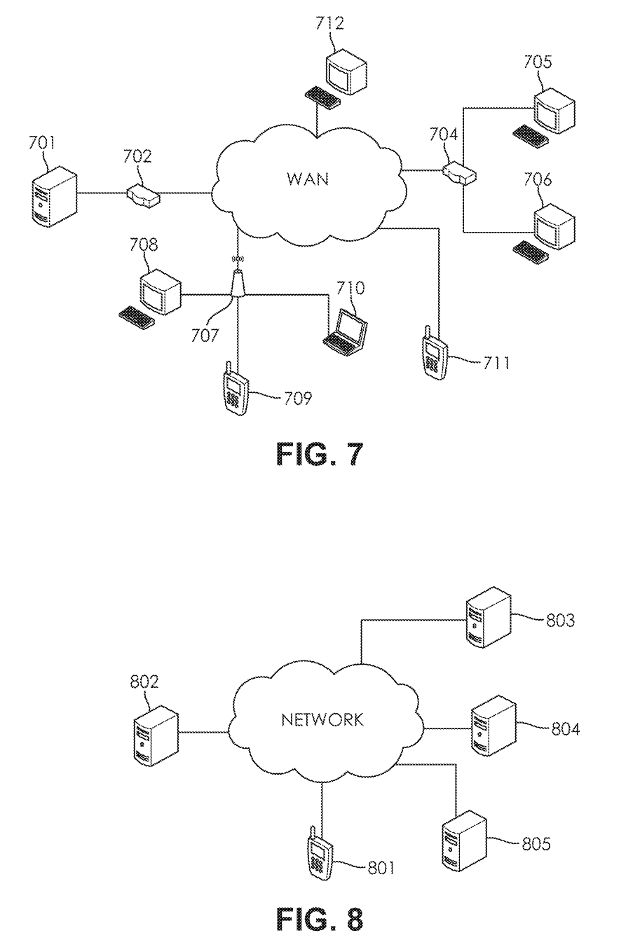

Error! No sequence specified. FIG. 7 is an illustration of a network diagram for a cloud based portion of the system, in accordance with an embodiment of the present invention; and

Error! No sequence specified. FIG. 8 is an illustration of a network diagram for a cloud based portion of the system, in accordance with an embodiment of the present invention.

### DETAILED SPECIFICATION

Error! No sequence specified. Embodiments of the present invention are related to systems and methods for comparing ETF portfolios based on internal composition. Specifically, embodiments of the present invention are directed at automated system and methods for analyzing and generating measurements between two or more ETFs. Preferred embodiments of the invention leverage social network analysis (SNA) means and methods to compare constituents of portfolios in order to assist in measurements between such ETFs.

Error! No sequence specified. According to an embodiment of the present invention, the system and methods detailed herein leverage certain aspects of artificial intelligence, machine learning and social network analysis (SNA) to analyze and compare ETF portfolios. By affiliating data comprising a set of relationships (e.g., binary relationships) between members of various sets, representation of corresponding relationships between members can be achieved. While the preferred embodiment of the present invention is related to analyzing and comparing ETF portfolios, one of ordinary skill in the art would appreciate that the systems and methods herein could be utilized with the analysis and comparison of other investment vehicles as well, and embodiments of the present invention are contemplated for use with the analysis and comparison of any investment vehicle.

Error! No sequence specified. Affiliations data may comprise a set of binary relationships between members of two sets of items. For instance, the system can represent affiliations as mathematical graphs in which nodes correspond to entities (such as women and events) and lines correspond to ties of affiliation among the entities. Affiliations graphs have the property of bipartitions, which means that the graph's nodes can be partitioned into two classes such that all ties occur only between classes and never within classes.

Error! No sequence specified. Affiliation graphs or networks are often called “2-mode graphs”. The terminology of “modes” refers to the number of different kinds of entities referenced in the rows and columns of a matrix. A 1-mode matrix is square, its rows and columns refer to the same set of entities.

Error! No sequence specified. In adopting co-affiliations as a proxy for social ties, the concept of social proximity is confounded with that of social similarity, which in other contexts are treated as competing alternatives.

Error! No sequence specified. In a traditional Social Network analysis (SNA), affiliation data consist of a set of binary relationships between members of two sets of items. Suppose there are number M people and N events, then each person will have an N dimension vector. Each component of the vector is the 1 (representing attend) and 0 (representing not attend). In our case, each ETF is similar to a point of person and each constituent of stock is similar to an event.

Error! No sequence specified. For instance, each row of a matrix is may be a vector representing an ETF. As such, the Minkowski norm could be used to calculate one distance between two ETFs, which is defined as below: The Minkowski distance of order one between two points:

X=X₁,X₂ . . . Xₙ),Y=(Y₁,Y₂ . . . Yₙ)

is defined as:

(Σₖ₌₁ⁿ|Xₖ−Yₖ|^{p})^{1/p}

Error! No sequence specified. Here, using the norm one distance of Minkowski distance. The distance is defined as Minkowski norm 1 since, in this case, reality mining have the differences in distance. For instance, the distance between an ETF 1 and an ETF 2 may be 2, which means there are two constituents between ETF 1 and ETF 2 that are different.

Error! No sequence specified. Considering that there may be a very large universe of all the possible constituents, two ETFs may actually contain a small number of total constituents. Just like in Social Network Analysis, the union is just a subset of all the events. Thus, in a preferred embodiment, SSii is denoted as the set of stocks (i.e., constituents) that ETF 1 contains, then the distance between two ETF, EEii and EEjj with normalization by the achievable stocks would be the following:

$${d}_{i , j} = \frac{{\sum }_{k = 1}^{n} {\vert {E}_{i} - {E}_{j} \vert}^{1}}{{s}_{i} ⋃ {s}_{j}}$$

which can be illustrated by the following:

$${ETF j}_{1 \; 0}$$

$$\begin{matrix}ETF i & 1 \\ & 0\end{matrix} \begin{matrix}a & b \\ c & d\end{matrix}$$

$${d}_{i , j} = \frac{b + c}{a + b + c}$$

Error! No sequence specified. By doing this, it gives the number of constituents that ETFs have in common as a proportion of constituents that are “attendable”, as determined by at least one of the two ETF contains the constituent.

Error! No sequence specified. According to an embodiment of the present invention, in practice, the system may assign different weights to each constituent. Take weighting into consideration, the system takes a matrix, then, using this matrix, the system calculates the L1 norm Minkowski distance. In this case, the distance is defined as:

d_{i,j}=½Σₖ₌₁ⁿ|Eᵢ−Eⱼ|¹

Error! No sequence specified. For instance, in one example, the distance between ETF 1 and ETF 2 could be 0.6, which means, considering factoring, there is 60% difference between ETF 1 and ETF 2.

Error! No sequence specified. In reality, there is dimension problem involved with using constituent data of an ETF alone, since the universe of the constituents would be a very large number. Thus, in the following models, the system is configured to utilize certain methods to fix the dimension problem. These methods are detailed further below. But before getting there, another problem with a basic model exists, in that the basic model only considers about which constituents an ETF contains, but neglect the information/correlation between constituents. In the following model, embodiments of the system solve these problems in a variety of ways.

Error! No sequence specified. Due to the problem mentioned above, embodiments of the system may be configured to group the constituents first to reduce the dimension of the matrix. For instance, first, the system may allocate each constituent into different industries and calculate the covariance matrix among them. Second, the system may calculate the variance of the difference between a base portfolio and each ETF using the difference of their holdings and the industrial covariance matrix. The smaller the variance of the difference, the more similar the ETF is to the base portfolio. The base portfolio may be, for instance, a particular ETF selected by the user, the system or other operator, or an imaginary ETF, that has been, for instance, generated by the system based on certain parameters (e.g., mix of constituents in certain industries or in certain indexes), or by a user or other operator based on various selections (e.g., selecting various constituents).

Error! No sequence specified. For instance, in a preferred embodiment, for ETFs that have the needed internal portfolio composition, the system may use the original holdings to calculate variance in the following steps. In this example, for the covariance matrix, the system may apply a time period based covariance (e.g., 3-month covariance rolled monthly) and weight the sum between it and a second time period based covariance (e.g., one-year covariance) matrix (e.g., (40%*1 yr covariance)+(60%*3-month covariance)).

Error! No sequence specified. In certain embodiments, to build a network analysis model with normalization and factoring to capture the relation between a ETF and the base portfolio, the system is configured to analyze the correlation between constituents. For instance, ETF A has MSFT and ETF B has AAPL. Though these are two different constituents, there is significant correlation between the two. Thus, the system may calculate a covariance matrix to capture the feature.

Error! No sequence specified. The classic problem arising when calculating the covariance matrix is the curse of dimensionality. If the number of constituents is large (e.g., 100's, 1000's), the historical dataset to calculate the covariance matrix would be very large. Therefore, in preferred embodiments of the present invention, the system may be configured to reduce the dimension before calculating the covariance matrix.

Error! No sequence specified. For instance, embodiments of the present invention could provide a system configured to use clustering to cluster the constituents. Thus, the system may be configured to allocate the constituents to different industries and gain a new matrix of return. Rᵢ, which means the ith ETF with the corresponding jth industry. The, is the weighting sum of the constituent return in the ith ETF and jth industry.

Error! No sequence specified. According to an embodiment of the present invention, the system could then use this matrix R to calculate the covariance matrix, denoted as/between different industries. Then, considering the variance inside the industry will have some impact to the network analysis. For instance, first, the system could be configured to use the Euclidean distance to calculate the value between the base portfolio and the ETF. The system could use every row of matrix R to subtract the return of the base portfolio, and get a difference matrix, denoted as ΔR. The system could then assign the covariance value as a penalty to the difference matrix. Thus, the total distance would be:

$${d}_{i , j} = \sqrt[2]{Δ R \sum Δ {R}^{T}}$$

Error! No sequence specified. Based on this methodology, the system may be configured to sample a data set of ETFs and use, for instance, a time period based pricing data analysis (e.g., half year of daily price data) of each constituent in the ETFs to provide a result with rolling averages (e.g., 3-month correlation rolled monthly then averaged) and generate a correlation therefrom. The results would show the distance between two or more ETFs and/or a base portfolio.

Error! No sequence specified. In other embodiments of the present invention, the system may be configured to use other elements to capture the features of ETF to identify similarities. The previous model as calculated with the actual number constituents shared and the returned difference may be referred to as an “Explicit” model. The system may be configured to modify the “Explicit” model to look at feature set(s) instead of actual constituents. In this manner, the system can create a series of scores that should give a result set similar to the results of the explicit model.

Error! No sequence specified. For instance, the system can be configured to define a feature set (F) as a set of exposures that would generalize the underlying constituents into specific groups instead of actual tickers/ISINs/SEDOLs/CUSIPs/etc. For example, feature sets could be Sector, Industry, Maturity, Coupons and/or Geographic exposures. Instead of passing the explicit model a list of constituents, the system may be provided Fₙ where

n=unique feature sets

Error! No sequence specified. With Fₙ, the system may be configured to: 1) score the ETFs based on the individual feature sets; and 2) create a weighted average score based on n feature sets, which would allow the system to determine the significance of each F based on their views. In this manner, the system gains scalability and breadth by enabling running the model on any ETF that the system has feature sets on. In this manner, the system is configured to handle the equity ETFs comparison, and the system may thus choose Industry, Geography, and Currency as the feature set.

Error! No sequence specified. For each feature set, the system can perform a SNA model analysis. In particular, embodiments of the present invention may provide SNA model analysis comprising: 1) model without factoring and normalization; 2) model with normalization; and/or 3) model with factoring.

Error! No sequence specified. In an exemplary model, for instance, the system may calculate the pairwise distance. Suppose, for instance the distance matrix calculated for the three features D_{ind}, D_{Geo}, D_{Cur}, then the combined model of the three features would be D_{i,j}=w₁D_{ind}+w₂D_{Geo}+w₃D_{Cur}, where w is the weighting of three features assigned by the system or its users.

Error! No sequence specified. Similar to the traditional SNA approach, the system can normalize a result by the total number of unique features in two ETFs and make the distance a percentage of the union of two ETFs. The following tables are the normalized distances calculated with industry, geographic, currency features and their equally weighted combination.

Error! No sequence specified. Turning now to FIG. 1, one exemplary process in accordance with an embodiment of the present invention is shown. In this FIG. 1, the process starts at step 101 with the user engaging the system for the purpose of having an ETF comparison completed. At step 102, the system receives an ETF comparison request. The ETF comparison request generally comprises the initial information required by the system to complete the analysis. In other embodiments, the ETF comparison request can simply comprise a request for a global or other broad ETF comparison that will be dictated by parameters available to the system (e.g., stored preferences, general preferences).

Error! No sequence specified. At step 103, the system retrieves relevant ETF data to be compared in the analysis. ETF data may include, but is not limited to, ETF names, constituents held by ETFs, industries ETFs trades in, geographic location of ETFs, director/management profiles, historic data (e.g., returns, formation date, YTD gians/losses), or any combination thereof. One of ordinary skill in the art would appreciate that there are numerous types of ETF data that could be retrieved and utilized by the system, and embodiments of the present invention are configured for use with any type of relevant ETF data. Further, ETF data may be retrieved from one or more local or remote data stores, such as, but not limited to, local storage disk, local memory, remote data provider, networked data provider, retrieved from a third-party system via an accessibility means, such as an application programming interface (API) or any combination thereof. One of ordinary skill in the art would appreciate that there are numerous methods and means for storing and retrieving data and embodiments of the present invention are contemplated for use with any appropriate storage and retrieval method and/or means.

Error! No sequence specified. At step 104, once the system has the initial set of ETF data it needs for processing, the system generates a grouping of constituents in the various ETF to be compared into various industries. As detailed elsewhere herein, this helps to remove or reduce the problem of dimension. Similarly, the process at step 104 may be modified in other embodiments to group constituents on other metrics other than industry, such as geographic location, management team, investment philosophy, or other metric.

Error! No sequence specified. At this point, the system may check to see if appropriate historical data is available to process the request an advanced model generation (Step 201) (Decision step 105). If there is not enough historical data available, the system will proceed to generate a standard model (step 106).

Error! No sequence specified. In the advanced model the system can generate a covariance matrix between two or more ETFs through a social network analysis modeling system as detailed earlier herein. Exemplary methods for generating such models can be seen in FIGS. 3A-3B provided herein and the related description below.

Error! No sequence specified. Turning now to FIG. 2, an exemplary method for generating an advanced model, in accordance with an embodiment of the present invention, is shown. The process starts at step 201 with the system being engaged to generate an advanced model. At step 202, the system receives the grouped constituent information generated earlier and parses the information in preparation for generating the advanced model.

Error! No sequence specified. At step 203, the system calculates a covariance matrix of the various industries of constituents identified in relation to the ETF data. Generation of the covariance matrix can be done, for example, as detailed earlier herein. At step 204, the system may generate a graphical display of the distances between the two or more ETFs identified. Graphical display of the distances may be useful to help users see and comprehend the distances, and graphical display may be effected by one or more graphs, charts or other visual aid, and may be provided, for instance, via a graphical user interface (GUI) on one or more display elements of a computing device.

Error! No sequence specified. At step 205, the system defines new features and binary vector distances to further improve upon the accuracy of the advanced model. As detailed above, the system may define new feature sets based on certain criteria/data associated with a constituent or ETF (e.g., sector, industry, maturity, coupons, geographic exposures) and generate binary vector distances based on the new feature set(s). This allows for further detail and classification of ETFs in relation to one another.

Error! No sequence specified. At step 206, the system performs a weighting of the distances between the ETFs that were requested to be compared and scores the ETFs. Once compared, the resulting data is generally processed into a graphical display element that can be provided to users as a visual representation of the calculated distances between the ETFs. The graphical display elements may be transmitted to or otherwise provided to a display element for consumption by the end user(s). At this point, the process terminates at step 207.

Error! No sequence specified. Turning now to FIGS. 3A and 3B, two exemplary intermediate processes for calculating distances between ETFs are shown. These methods could be used independent or in conjunction with one another and can be used in both the advanced and standard model generation methods detailed above. Starting with FIG. 3A, the process starts at step 300 with the system being engaged to process ETF data with a feature set based on industry of constituents. At step 301, the system uses known data about constituents to allocate each constituent (i.e., equities) into various industries determined by the system.

Error! No sequence specified. At step 302, the system generates or retrieves a base portfolio. As detailed previously herein, the base portfolio can be used as a baseline upon which distances for all other ETFs to be compared will be calculated from. Optionally, at step 303, the system clusters equities in order to reduce dimension, as detailed previously herein. Further, optionally, the system may do a “pairwise” comparison of a group of ETFs that would result in a matrix of distances, similar to a correlation matrix.

Error! No sequence specified. At step 304, the system calculates the variance of various the ETFs. For instance, the system may calculate the variance of the difference between the base portfolio and each ETF using the difference of their holdings and the industrial covariance matrix. The smaller the variance of the difference, the more similar the ETF is to the base portfolio.

Error! No sequence specified. At step 305, the system uses the calculated variance to further calculate the distance between the ETFs. Once compared, the resulting data is generally processed into a graphical display element that can be provided to users as a visual representation of the calculated distances between the ETFs. The graphical display elements may be transmitted to or otherwise provided to a display element for consumption by the end user(s). In other embodiments, the data may be returned to a process for further refinement, such as further calculation of distances based on other features. At this point, the process terminates at step 306.

Error! No sequence specified. Turning now to FIG. 3B, an intermediate process for calculating distances between ETFs based on feature sets, in accordance with an embodiment of the present invention, is shown. At step 307, the process starts with data being provided to the system. At step 308, the system defines a feature set (e.g., industry, geographic location, etc). The feature set can be automatically defined by the system, or in other embodiments, the system may be configured to accept data (e.g., from user input) to be used in defining the feature set.

Error! No sequence specified. At step 309, the system uses the defined feature set to generate a set of ETFs based on the identified feature set. In this manner, the ETFs are selected based on the selected features, as opposed to previous descriptions herein where the ETFs were initially selected. In this manner, the system can be configured to identify potential ETFs, such as for investors looking for ETFs with particular characteristics.

Error! No sequence specified. At step 310, the system calculates the distances between the ETFs At step 311, the system generates a weighted average for the ETF set. Weighting of the averages for ETFs can be done as detailed previously herein. Once compared, the resulting data is generally processed into a graphical display element that can be provided to users as a visual representation of the calculated distances between the ETFs. The graphical display elements may be transmitted to or otherwise provided to a display element for consumption by the end user(s). In other embodiments, the data may be returned to a process for further refinement, such as further calculation of distances based on other features. At this point, the process terminates at step 312.

Error! No sequence specified. According to an embodiment of the present invention, the system and method may be configured to share and or receive data to and may be used in conjunction or through the use of one or more computing devices. As shown in FIG. 4, One of ordinary skill in the art would appreciate that a computing device 400 appropriate for use with embodiments of the present application may generally be comprised of one or more of a Central processing Unit (CPU) 401, Random Access Memory (RAM) 402, a storage medium (e.g., hard disk drive, solid state drive, flash memory, cloud storage) 403, an operating system (OS) 404, one or more application software 405, one or more display elements 406, one or more input/output devices/means 407 and one or more databases 408. Examples of computing devices usable with embodiments of the present invention include, but are not limited to, personal computers, smartphones, laptops, mobile computing devices, tablet PCs and servers. Certain computing devices configured for use with the system do not need all the components described in FIG. 4. For instance, a server may not necessarily include a display element. The term computing device may also describe two or more computing devices communicatively linked in a manner as to distribute and share one or more resources, such as clustered computing devices and server banks/farms. One of ordinary skill in the art would understand that any number of computing devices could be used, and embodiments of the present invention are contemplated for use with any computing device.

Error! No sequence specified. Turning to FIG. 5, according to an embodiment of the present invention, a system for generating travel itineraries based on user interests is comprised of one or more communications means 501, one or more data stores 502, a processor 503, memory 504, a Social Network Analysis module 505 and an ETF Analysis module 506. FIG. 6 shows an alternative embodiment of the present invention, comprised of one or more communications means 601, one or more data stores 602, a processor 603, memory 604, an Social Network Analysis module 605, an ETF Analysis module 606 and a Machine Learning Driven Suggestion module 607. The various modules described herein provide functionality to the system, but the features described and functionality provided may be distributed in any number of modules, depending on various implementation strategies. One of ordinary skill in the art would appreciate that the system may be operable with any number of modules, depending on implementation, and embodiments of the present invention are contemplated for use with any such division or combination of modules as required by any particular implementation. In alternate embodiments, the system may have additional or fewer components. One of ordinary skill in the art would appreciate that the system may be operable with a number of optional components, and embodiments of the present invention are contemplated for use with any such optional component.

Error! No sequence specified. According to an embodiment of the present invention, the Social Network Analysis module is configured to provide the system with methodologies and means for analyzing and determining distance between constituents of a data set, as detailed herein. For instance, the Social Network Analysis module may be configured to generate and analyze co-affiliation matrices and distance metrics. One of ordinary skill in the art would appreciate that there are numerous types of methodologies and means that could be provided by the Social Network Analysis module, and embodiments of the present invention are contemplated for any appropriate methodologies and means.

Error! No sequence specified. According to an embodiment of the present invention, the ETF Analysis module is configured to provide the system with methodologies and means for analyzing and processing ETF data, such as various data elements associated with various constituents. For instance, the ETF Analysis module may be configured to group constituents by various data elements, process historical data on each constituent, and define new features and binary vector distances between constituents. One of ordinary skill in the art would appreciate that there are numerous types of methodologies and means that could be provided by the ETF Analysis module, and embodiments of the present invention are contemplated for any appropriate methodologies and means.

Error! No sequence specified. According to an embodiment of the present invention, the Machine Learning Driven Suggestion module is configured to provide the system with methodologies and means for automating the training and improvement of analysis of various aspects of the present invention. In certain embodiments, the Machine Learning Driven Suggestion module is configured to use data generated by the system to further train and improve accuracy of calculated distances and features of the various modules of which the system is comprised. One of ordinary skill in the art would appreciate that there are numerous types of methodologies and means that could be provided by the Machine Learning Driven Suggestion module, and embodiments of the present invention are contemplated for any appropriate methodologies and means.

Error! No sequence specified. Throughout this disclosure and elsewhere, block diagrams and flowchart illustrations depict methods, apparatuses (i.e., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “circuit,” “module,” or “system.”

Error! No sequence specified. While the foregoing drawings and description set forth functional aspects of the disclosed systems, no particular arrangement of software for implementing these functional aspects should be inferred from these descriptions unless explicitly stated or otherwise clear from the context.

Error! No sequence specified. Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

Error! No sequence specified. In an exemplary embodiment according to the present invention, data may be provided to the system, stored by the system and provided by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present invention are contemplated for use with any configuration.

Error! No sequence specified. Referring to FIG. 7, a schematic overview of a cloud based system in accordance with an embodiment of the present invention is shown. The cloud based system is comprised of one or more application servers 703 for electronically storing information used by the system. Applications in the application server 203 may retrieve and manipulate information in storage devices and exchange information through a Network 701 (e.g., the Internet, a LAN, WiFi, Bluetooth, etc.). Applications in server 703 may also be used to manipulate information stored remotely and process and analyze data stored remotely across a Network 701 (e.g., the Internet, a LAN, WiFi, Bluetooth, etc.).

Error! No sequence specified. According to an exemplary embodiment, as shown in FIG. 7, exchange of information through the Network 701 may occur through one or more high speed connections. In some cases, high speed connections may be over-the-air (OTA), passed through networked systems, directly connected to one or more Networks 701 or directed through one or more routers 702. Router(s) 702 are completely optional and other embodiments in accordance with the present invention may or may not utilize one or more routers 702. One of ordinary skill in the art would appreciate that there are numerous ways server 703 may connect to Network 701 for the exchange of information, and embodiments of the present invention are contemplated for use with any method for connecting to networks for the purpose of exchanging information. Further, while this application refers to high speed connections, embodiments of the present invention may be utilized with connections of any speed.

Error! No sequence specified. Components of the system may connect to server 703 via Network 701 or other network in numerous ways. For instance, a component may connect to the system i) through a computing device 712 directly connected to the Network 701, ii) through a computing device 705, 706 connected to the WAN 701 through a routing device 704, iii) through a computing device 708, 709, 710 connected to a wireless access point 707 or iv) through a computing device 711 via a wireless connection (e.g., CDMA, GMS, 3G, 4G) to the Network 701. One of ordinary skill in the art would appreciate that there are numerous ways that a component may connect to server 703 via Network 701, and embodiments of the present invention are contemplated for use with any method for connecting to server 703 via Network 701. Furthermore, server 703 could be comprised of a personal computing device, such as a smartphone, acting as a host for other computing devices to connect to.

Error! No sequence specified. Turning now to FIG. 8, a continued schematic overview of a cloud based system in accordance with an embodiment of the present invention is shown. In FIG. 8, the cloud based system is shown as it may interact with users and other third party networks or APIs. For instance, a user of a mobile device 801 may be able to connect to application server 802. Application server 802 may be able to enhance or otherwise provide additional services to the user by requesting and receiving information from one or more of an external content provider API/website or other third party system 803, a constituent data service 804, one or more additional ETF data services 805 or any combination thereof. Additionally, application server 802 may be able to enhance or otherwise provide additional services to an external content provider API/website or other third party system 803, a constituent data service 804, one or more additional ETF data services 805 by providing information to those entities that is stored on a database that is connected to the application server 802. One of ordinary skill in the art would appreciate how accessing one or more third-party systems could augment the ability of the system described herein, and embodiments of the present invention are contemplated for use with any third-party system.

Error! No sequence specified. Traditionally, a computer program consists of a finite sequence of computational instructions or program instructions. It will be appreciated that a programmable apparatus (i.e., computing device) can receive such a computer program and, by processing the computational instructions thereof, produce a further technical effect.

Error! No sequence specified. A programmable apparatus includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of at least one general purpose computer, special-purpose computer, programmable data processing apparatus, processor, processor architecture, and so on.

Error! No sequence specified. It will be understood that a computer can include a computer-readable storage medium and that this medium may be internal or external, removable and replaceable, or fixed. It will also be understood that a computer can include a Basic Input/Output System (BIOS), firmware, an operating system, a database, or the like that can include, interface with, or support the software and hardware described herein.

Error! No sequence specified. Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Error! No sequence specified. Regardless of the type of computer program or computer involved, a computer program can be loaded onto a computer to produce a particular machine that can perform any and all of the depicted functions. This particular machine provides a means for carrying out any and all of the depicted functions.

Error! No sequence specified. Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Error! No sequence specified. Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

Error! No sequence specified. A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Error! No sequence specified. Program code embodied on a computer readable medium may be transmitted using any appropriate medium, including but not limited to wireless, wireline, optical fiber cable, RF, etc., or any suitable combination of the foregoing.

Error! No sequence specified. The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these. All such implementations are within the scope of the present disclosure.

Error! No sequence specified. In view of the foregoing, it will now be appreciated that elements of the block diagrams and flowchart illustrations support combinations of means for performing the specified functions, combinations of steps for performing the specified functions, program instruction means for performing the specified functions, and so on.

Error! No sequence specified. It will be appreciated that computer program instructions may include computer executable code. A variety of languages for expressing computer program instructions are possible, including without limitation C, C++, Java, JavaScript, Python, assembly language, Lisp, and so on. Such languages may include assembly languages, hardware description languages, database programming languages, functional programming languages, imperative programming languages, and so on. In some embodiments, computer program instructions can be stored, compiled, or interpreted to run on a computer, a programmable data processing apparatus, a heterogeneous combination of processors or processor architectures, and so on.

Error! No sequence specified. In some embodiments, a computer enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computer can process these threads based on priority or any other order based on instructions provided in the program code.

Error! No sequence specified. Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

Error! No sequence specified. The functions and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, embodiments of the invention are not described with reference to any particular programming language. It is appreciated that a variety of programming languages may be used to implement the present teachings as described herein, and any references to specific languages are provided for disclosure of enablement and best mode of embodiments of the invention. Embodiments of the invention are well suited to a wide variety of computer network systems over numerous topologies. Within this field, the configuration and management of large networks include storage devices and computers that are communicatively coupled to dissimilar computers and storage devices over a network, such as the Internet.

Error! No sequence specified. The functions, systems and methods herein described could be utilized and presented in a multitude of languages. Individual systems may be presented in one or more languages and the language may be changed with ease at any point in the process or methods described above. One of ordinary skill in the art would appreciate that there are numerous languages the system could be provided in, and embodiments of the present invention are contemplated for use with any language.

Error! No sequence specified. While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A system for comparing ETF portfolios based on internal composition and analysis of makeup of the portfolios, said system comprising:
a computer processor;
a non-volatile computer-readable memory; and
a data communication interface,
wherein the non-volatile computer-readable memory is communicatively connected to said processor and data communication interface and is configured with computer instructions configured to:
receive an investment vehicle comparison request from a user;
retrieve data associated with a plurality of investments, wherein each investment of said investments matches a type of investment identified in said investment vehicle comparison request;
analyze constituents of each investment of said plurality of investments;
calculate variance of investment vehicles, based at least in part on analysis of said constituents of each investment of said plurality of investments;
calculate distance between said investment vehicles; and
provide graphical display data related to calculated distance between said investment vehicles via said data communication interface.

2. The system of claim 1, wherein the non-volatile computer-readable memory is further configured with computer instructions configured to cluster constituents of each investment of said plurality of investments based on one or more criteria associated with each constituent.

3. The system of claim 2, wherein a covariance matrix is calculated between said constituents, wherein said covariance matrix details the distance between each of said constituents.

4. The system of claim 3, wherein the criteria associated with each constituent is selected from the group comprising industry, geography and currency.

5. The system of claim 1, wherein the non-volatile computer-readable memory is further configured with computer instructions configured to allocate each constituent to a specific industry.

6. The system of claim 5, wherein the non-volatile computer-readable memory is further configured with computer instructions configured to cluster constituents of each investment of said plurality of investments based on the specific industry of said constituent.

7. The system of claim 1, wherein the non-volatile computer-readable memory is further configured with computer instructions configured to define a feature set of each investment of said plurality of investments based on one or more criteria associated with each constituent.

8. The system of claim 7, wherein the non-volatile computer-readable memory is further configured with computer instructions configured to generate a weighted average of each investment of said plurality of investments based said defined feature set.

9. The system of claim 1, wherein the non-volatile computer-readable memory is further configured with computer instructions configured to generate a base portfolio.

10. A method for comparing ETF portfolios based on internal composition and analysis of makeup of the portfolios, said method comprising the steps of:
receiving an investment vehicle comparison request from a user;
retrieving data associated with a plurality of investments, wherein each investment of said investments matches a type of investment identified in said investment vehicle comparison request;
analyzing constituents of each investment of said plurality of investments;
calculating variance of investment vehicles, based at least in part on analysis of said constituents of each investment of said plurality of investments;
calculating distance between said investment vehicles; and
providing graphical display data related to calculated distance between said investment vehicles via said data communication interface.

11. The method of claim 10, further comprising the step of clustering constituents of each investment of said plurality of investments based on one or more criteria associated with each constituent.

12. The method of claim 11, further comprising the step of calculating a covariance matrix between said constituents, wherein said covariance matrix details the distance between each of said constituents.

13. The method of claim 12, wherein the criteria associated with each constituent is selected from the group comprising industry, geography and currency.

14. The method of claim 10, further comprising the step of allocating each constituent to a specific industry.

15. The method of claim 10, further comprising the step of clustering constituents of each investment of said plurality of investments based on the specific industry of said constituent.

16. The method of claim 10, further comprising the step of defining a feature set of each investment of said plurality of investments based on one or more criteria associated with each constituent.

17. The method of claim 10, further comprising the step of generating a weighted average of each investment of said plurality of investments based said defined feature set.

18. The method of claim 10, further comprising the step of generating a base portfolio.
